(19) United States
(12) Patent Application Publication
(10) Pub. No.: US 2024/0262032 A1
(43) Pub. Date: Aug. 8, 2024

(54) METHOD FOR THE ADDITIVE MANUFACTURE OF COMPONENTS, IN WHICH A COMPONENT IS PRODUCED BY DEPOSITING AT LEAST ONE MATERIAL IN THE FORM OF DROPLETS

(71) Applicant: Fraunhofer-Gesellschaft zur Förderung der Angewandten Forschung E.V., München (DE)

(72) Inventors: Uwe SCHEITHAUER, Dresden (DE); Steven WEINGARTEN, Dresden (DE); Valentin LANG, Dresden (DE); Felix GLAUSCH, Dresden (DE); Hajo WIEMER, Dresden (DE)

(21) Appl. No.: 18/570,115

(22) PCT Filed: Jun. 2, 2022
(86) PCT No.: PCT/EP2022/065065

§ 371 Date: Dec. 14, 2023

(30) Foreign Application Priority Data
Jun. 15, 2021 (DE) 10 2021 115 402.2

(51) Int. Cl. B29C 64/112; B29C 64/194; B29C 64/268; B29C 64/30; B33Y 10/00; B33Y 40/00

(52) U.S. Cl. CPC B29C 64/112; B29C 64/194; B29C 64/268; B29C 64/30; B33Y 10/00; B33Y 40/00

(57) ABSTRACT

A component is produced by depositing at least one material in the form of droplets. The droplets are arranged next to and/or on top of each other in layers, where the surface is smoothed after the deposition of individual droplets with a laser beam so that material is removed at elevations and/or the viscosity and/or the surface tension of the respective material is reduced in the area around depressions with the laser beam so that a flow for at least partial filling of depressions is achieved to reduce surface roughness. A locally defined material removal can be carried out alone or in addition to this to set surface properties or form structures whose dimensions are below the resolution capacity of the additive process, as the deposited droplets have a larger diameter, and then curing, melting, debinding and/or sintering is carried out to complete the respective component.

The invention relates to a method for the additive manufacturing of components, in which a component is produced by depositing at least one material in the form of droplets. It therefore falls into the field of additive manufacturing and is also suitable for the production of components that are manufactured using several different materials, such as composite components.

Up to now, it has also been known to produce components by placing individual droplets next to and/or on top of each other. With a suitable consistency and viscosity, the droplets can be deposited from nozzles drop by drop or by a pressure device, so that a three-dimensional component can be obtained after curing or sintering.

Typical droplet sizes are in the range of 200 μm to 500 μm, which also limits the resolution in additive manufacturing using such droplets. As a result of the individual deposition, the viscosity and the surface tension of the individual droplets, gussets form between adjacent and/or superimposed droplets as depressions at the edges of the individual droplets and elevations between them, which impair the surface quality and result in relatively rough surfaces on a finished component.

Mechanical post-processing, which is carried out after drying or curing or sintering to counteract this disadvantage, leads to high costs, as it requires time, additional plant technology, usually processing at a different location and removal of solid removed material. Areas of components manufactured in this way are also inaccessible or very difficult to access from the outside, so that no or only very complex surface finishing can be carried out there. These can be areas in cavities or undercuts.

It is therefore the object of the invention to specify possibilities for improving/targeted adjustment of the surface quality on parts produced using an additive manufacturing process in which material is deposited drop by drop, which makes it possible to reduce the effort involved. It should also be possible to produce component structures with finer, more delicate dimensions and structural elements.

This object is achieved according to the invention by a method having the features of claim 1. Advantageous embodiments and refinements of the invention can be implemented with features set out in the dependent claims.

In the method, the droplets are arranged next to and/or on top of each other in layers. The surface is smoothed immediately after the deposition of individual droplets using the energy of a laser beam whose focal spot is directed at elevations formed on droplets. This can also smooth out the side walls of the deposited droplets.

The focal spot of a laser beam is therefore immediately after deposition and before any further processing, in particular drying, curing, fusing or sintering, is carried out.

Smoothing can be carried out in such a way that
material is removed in the area of elevations in such a way that the surface roughness is reduced to a specified level. Material removal can preferably be achieved by ablation or sublimation.

Alone or in addition to the material removal, in the region around pinch-shaped depressions which have been formed between individual droplets arranged side by side, with the energy of the laser beam, the focal spot of which is directed in regions of the droplets arranged side by side close to the depressions in such a way that the viscosity and/or the surface tension of the respective material is reduced there in such a way that a flow for at least partial filling of depressions is achieved in such a way that the surface roughness has been reduced to a predetermined degree. A locally defined temperature increase can therefore be utilized to reduce the depth and volume of droplet volume in depressions by flowing the material, thus achieving surface smoothing.

In a further alternative according to the invention, which can also be carried out in combination with at least one of the previously mentioned alternatives, a locally defined removal of material is carried out in order to specifically adjust surface properties or form structures whose dimensions are below the resolution capacity of the additive process, since the deposited droplets have a larger diameter.

This is followed by curing, melting or sintering to complete the respective component.

The material used to form droplets can be a polymer and/or a suspension containing solids. Polymers include a large number of organic compounds, including copolymers and monomers. A suspension can be formed with a liquid containing solid particles or fibers and at least one organic binder. A viscosity and surface tension should be maintained at the respective processing temperature during the deposition of the droplets so that droplets can form and no material can flow away.

Droplets of different materials can also be placed next to and/or on top of each other.

In the area of elevations, material can be removed and/or material can flow to at least partially fill depressions after droplets have been deposited in at least one ply to form a respective layer. However, this can also be carried out after a predetermined number of plies have been laid down, for example three or five plies.

Advantageously, the removal of material at elevations and/or a flow in the area around depressions can be carried out in a controlled manner. The surface topography can be detected with at least one optical sensor and influenced with spatially resolved height values, the deflection movement of the laser's focal spot and preferably also the power density in the focal spot of the laser beam. The deflection movement of the focal spot can be caused by a relative movement of the laser beam with its optical axis in relation to the respective surface of the respective component, i.e. also by a corresponding at least two-dimensional movement of a building platform on which a respective component is additively manufactured. However, the laser beam can also be deflected accordingly using suitable optical elements and, if necessary, also shaped.

When recording the surface topography, the position of elevations and depressions can be determined and thus the deflection movement of the material to the respective elevations for material removal and/or in the areas around pinch-shaped depressions can be carried out in one or more dimensions using so-called scanners.

The surface topography in particular can be determined with the at least one optical sensor and used for control. The dwell time at a position, the power density in the focal spot and the size of the instantaneous focal spot area can also be specifically influenced by additional, preferably non-contact, temperature determination in the area of influence of the focal spot. This is not only advantageous when removing material. It can also be used to influence the respective favorable temperature in the area of the droplet material, which leads to flow and thus to the filling of depressions with accompanying smoothing of the surface.

The temperature should be determined locally or selectively in order to be able to carry out locally defined control.

Particularly in the case of materials whose consistency makes them difficult or difficult to make flowable, it can be advantageous to soften the material of droplets with the laser beam energy and then to achieve mechanical deformation by applying or attaching a forming tool in order to achieve the desired plastic deformation, in which the surface can also be smoothed.

After creating a layer or applying a material in the respective layer, green processing can be carried out directly by means of laser ablation or flow processing. Smoothing of the surfaces with a significant reduction in surface roughness can be achieved.

If this is desired, it is also possible to create certain geometric features far below the resolution limit of the drop-by-drop application process used by forming contour elements in the order of <50 μm instead of <500 μm with the locally defined material removal.

In addition, direct integration of green processing is possible by processing all surfaces, including the internal surfaces of the respective component. Processing immediately after the first material has been deposited, without any major time delay, allows the boundaries between different individual deposited droplets and possibly different materials to be designed more precisely if droplets of different materials have been deposited.

A significantly improved surface quality and interface geometry can be formed at the interfaces of droplets, with little additional effort required for the integration of laser processing.

1-7. (canceled)

8. A method for the additive production of components, in which a component is produced by depositing at least one material in the form of droplets, and the droplets are arranged next to and/or on top of one another in layers, comprising:
smoothing of the surface immediately after the deposition of individual droplets with the energy of a laser beam whose focal spot is applied to elevations of a respective ply takes place in that
material is removed in the region of elevations in such a way that the surface roughness is reduced to a predetermined level and/or
in the region around pinch-shaped depressions which have been formed between individual droplets arranged side by side, with the energy of the laser beam, the focal spot of which is directed in regions of the droplets arranged side by side close to the depressions in such a way that the viscosity and/or the surface tension of the respective material is reduced there in such a way that a flow for at least partial filling of depressions is achieved in such a way that the surface roughness has been reduced to a predetermined degree and/or
a locally defined removal of material takes place in order to specifically adjust surface properties or to form structures whose dimensions are below the resolution capacity of the additive process, as the deposited droplets have a larger diameter, and subsequently
curing, melting, debinding and/or sintering is carried out to complete the respective component.

9. A method according to claim 8, wherein a polymer and/or a suspension containing solids is used as the material with which droplets are formed.

10. A method according to claim 8, wherein in the region of elevations a material removal
and/or a flow of material for at least partial filling of depressions is carried out after the deposition of droplets in at least one layer for the formation of a respective layer.

11. A method according to claim 10, wherein material removal and/or flow is carried out after depositing a predeterminable number of plies with which layers are formed.

12. A method according to claim 8, wherein droplets of different materials are deposited next to and/or on top of each other.

13. A method according to claim 8, wherein the removal of material at elevations and/or a flow in the region around depressions is carried out in a controlled manner, the surface topography being detected with at least one optical sensor and influenced with spatially resolved height values, the deflection movement of the focal spot of the laser and preferably additionally the power density in the focal spot of the laser beam.

14. A method according to claim 13, wherein for the control, the temperature is determined spatially resolved or selectively.
